(19) United States
(12) Patent Application Publication
(10) Pub. No.: US 2017/0094568 A1
(43) Pub. Date: Mar. 30, 2017

(54) TUNE AWAY ADJUSTMENT PROCEDURE

(71) Applicant: QUALCOMM Incorporated, San Diego, CA (US)

(72) Inventors: Ming YANG, San Diego, CA (US); Tom CHIN, San Diego, CA (US)

(21) Appl. No.: 14/866,814

(22) Filed: Sep. 25, 2015

(51) Int. Cl. H04W 36/00; H04L 1/18

(52) U.S. Cl. CPC H04W 36/0094; H04L 1/1848

(57) ABSTRACT

In one instance, a user equipment (UE) compares an expected duration of a tune away procedure with a first time remaining before a discard timer expires, a second time remaining before a downlink reordering timer (DL reordering timer) for adjusting an order of data at a buffer expires, a third time remaining before a retransmission timer expires and/or a fourth time remaining before an expected time to receive acknowledgement feedback ends. The UE also determines whether to adjust a tune away procedure based on the comparing. The tune away procedure may include the UE tuning away from a first radio access technology (RAT) to a second RAT during a communication procedure at the first RAT.

### BACKGROUND

Field

Aspects of the present disclosure relate generally to wireless communication systems, and more particularly, to adjustment of procedure for tuning away from a first radio access technology (RAT) to a second RAT during a communication procedure at the first RAT.

Background

Wireless communication networks are widely deployed to provide various communication services, such as telephony, video, data, messaging, broadcasts, and so on. Such networks, which are usually multiple access networks, support communications for multiple users by sharing the available network resources. One example of such a network is the universal terrestrial radio access network (UTRAN). The UTRAN is the radio access network (RAN) defined as a part of the universal mobile telecommunications system (UMTS), a third generation (3G) mobile phone technology supported by the 3rd Generation Partnership Project (3GPP). The UMTS, which is the successor to global system for mobile communications (GSM) technologies, currently supports various air interface standards, such as wideband-code division multiple access (W-CDMA), time division-code division multiple access (TD-CDMA), and time division-synchronous code division multiple access (TD-SCDMA). For example, China employs TD-SCDMA as an underlying air interface in the UTRAN architecture with its existing GSM infrastructure as the core network. The UMTS also supports enhanced 3G data communications protocols, such as high speed packet access (HSPA), which provides higher data transfer speeds and capacity to associated UMTS networks. HSPA is a collection of two mobile telephony protocols, high speed downlink packet access (HSDPA) and high speed uplink packet access (HSUPA) that extends and improves the performance of existing wideband protocols.

As the demand for mobile broadband access continues to increase, there exists a need for further improvements in wireless technology. Preferably, these improvements should be applicable to LTE and other multi-access technologies and the telecommunication standards that employ these technologies.

### SUMMARY

According to one aspect of the present disclosure, a method of wireless communication includes comparing an expected duration of a tune away procedure with a first time remaining before a discard timer expires, a second time remaining before a downlink reordering timer (DL reordering timer) for adjusting an order of data at a buffer (e.g., a receive buffer) expires, a third time remaining before a retransmission timer expires and/or a fourth time remaining before an expected time to receive acknowledgement feedback ends. The method also includes determining whether to adjust the tune away procedure based on the comparing. The tune away procedure includes tuning away from a first RAT (radio access technology) to a second RAT.

According to another aspect of the present disclosure, an apparatus for wireless communication includes means for comparing an expected duration of a tune away procedure with a first time remaining before a discard timer expires, a second time remaining before a downlink reordering timer (DL reordering timer) for adjusting an order of data at a buffer (e.g., a receive buffer) expires, a third time remaining before a retransmission timer expires and/or a fourth time remaining before an expected time to receive acknowledgement feedback ends. The apparatus may also include means for determining whether to adjust the tune away procedure based on the comparing. The tune away procedure includes tuning away from a first RAT (radio access technology) to a second RAT.

Another aspect discloses an apparatus for wireless communication and includes a memory at least one processor coupled to the memory. The processor(s) is configured to compare an expected duration of a tune away procedure with a first time remaining before a discard timer expires, a second time remaining before a downlink reordering timer (DL reordering timer) for adjusting an order of data at a buffer (e.g., a receive buffer) expires, a third time remaining before a retransmission timer expires and/or a fourth time remaining before an expected time to receive acknowledgement feedback ends. The processor(s) is also configured to determine whether to adjust the tune away procedure based on the comparing. The tune away procedure includes tuning away from a first RAT (radio access technology) to a second RAT.

Yet another aspect discloses a computer program product for wireless communications in a wireless network having a non-transitory computer-readable medium. The computer-readable medium has non-transitory program code recorded thereon which, when executed by the processor(s), causes the processor(s) to compare an expected duration of a tune away procedure with a first time remaining before a discard timer expires, a second time remaining before a downlink reordering timer (DL reordering timer) for adjusting an order of data at a buffer (e.g., a receive buffer) expires, a third time remaining before a retransmission timer expires and/or a fourth time remaining before an expected time to receive acknowledgement feedback ends. The program code also causes the processor(s) to determine whether to adjust the tune away procedure based on the comparing. The tune away procedure includes tuning away from a first RAT (radio access technology) to a second RAT.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a diagram illustrating an example of a network architecture.

FIG. 2 is a diagram illustrating an example of a downlink frame structure in long term evolution (LTE).

FIG. 3 is a diagram illustrating an example of an uplink frame structure in long term evolution (LTE).

FIG. 4 is a diagram illustrating an example of a radio protocol architecture for the user and control plane.

FIG. 5 is a block diagram illustrating an example of a global system for mobile communications (GSM) frame structure.

FIG. 6 is a block diagram conceptually illustrating an example of a base station in communication with a user equipment (UE) with a single receive chain in a telecommunications system.

FIG. 7 is a diagram illustrating network coverage areas according to aspects of the present disclosure.

FIG. 8 illustrates an example of timelines for uplink transmissions and a tune away period.

FIGS. 9A and 9B are examples of timelines for uplink transmission illustrating a comparison of an expected tune away period and an uplink discard timer.

FIG. 10 is a block diagram illustrating a method for wireless communication with a single receive chain according to one aspect of the present disclosure.

FIG. 11 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

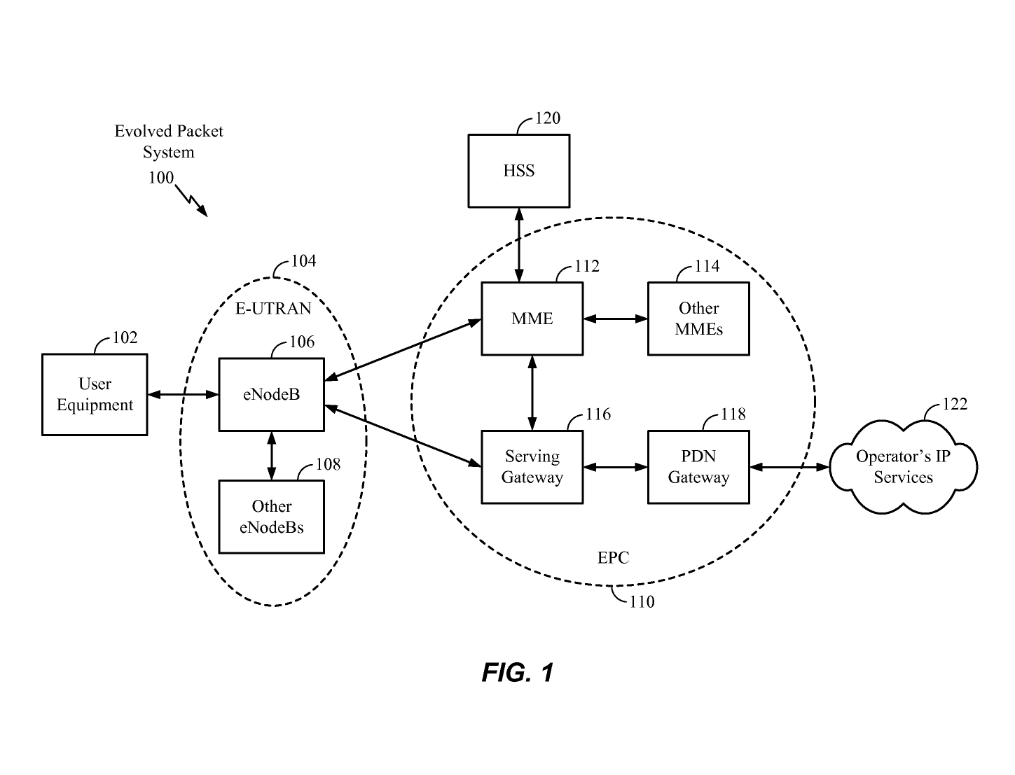

FIG. 1 is a diagram illustrating a network architecture 100 of a long-term evolution (LTE) network. The LTE network architecture 100 may be referred to as an evolved packet system (EPS) 100. The EPS 100 may include one or more user equipment (UE) 102, an evolved UMTS terrestrial radio access network (E-UTRAN) 104, an evolved packet core (EPC) 110, a home subscriber server (HSS) 120, and an operator's IP services 122. The EPS can interconnect with other access networks, but for simplicity, those entities/interfaces are not shown. As shown, the EPS 100 provides packet-switched services, however, as those skilled in the art will readily appreciate, the various concepts presented throughout this disclosure may be extended to networks providing circuit-switched services.

The E-UTRAN 104 includes an evolved Node B (eNodeB) 106 and other eNodeBs 108. The eNodeB 106 provides user and control plane protocol terminations toward the UE 102. The eNodeB 106 may be connected to the other eNodeBs 108 via a backhaul (e.g., an X2 interface). The eNodeB 106 may also be referred to as a base station, a base transceiver station, a radio base station, a radio transceiver, a transceiver function, a basic service set (BSS), an extended service set (ESS), or some other suitable terminology. The eNodeB 106 provides an access point to the EPC 110 for a UE 102. Examples of UEs 102 include a cellular phone, a smart phone, a session initiation protocol (SIP) phone, a laptop, a notebook, a netbook, a smartbook, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station or apparatus, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNodeB 106 is connected to the EPC 110 via, e.g., an S1 interface. The EPC 110 includes a mobility management entity (MME) 112, other MMEs 114, a serving gateway 116, and a packet data network (PDN) gateway 118. The MME 112 is the control node that processes the signaling between the UE 102 and the EPC 110. Generally, the MME 112 provides bearer and connection management. All user IP packets are transferred through the serving gateway 116, which itself is connected to the PDN gateway 118. The PDN gateway 118 provides UE IP address allocation as well as other functions. The PDN gateway 118 is connected to the operator's IP services 122. The operator's IP services 122 may include the Internet, the Intranet, an IP multimedia subsystem (IMS), and a PS streaming service (PSS).

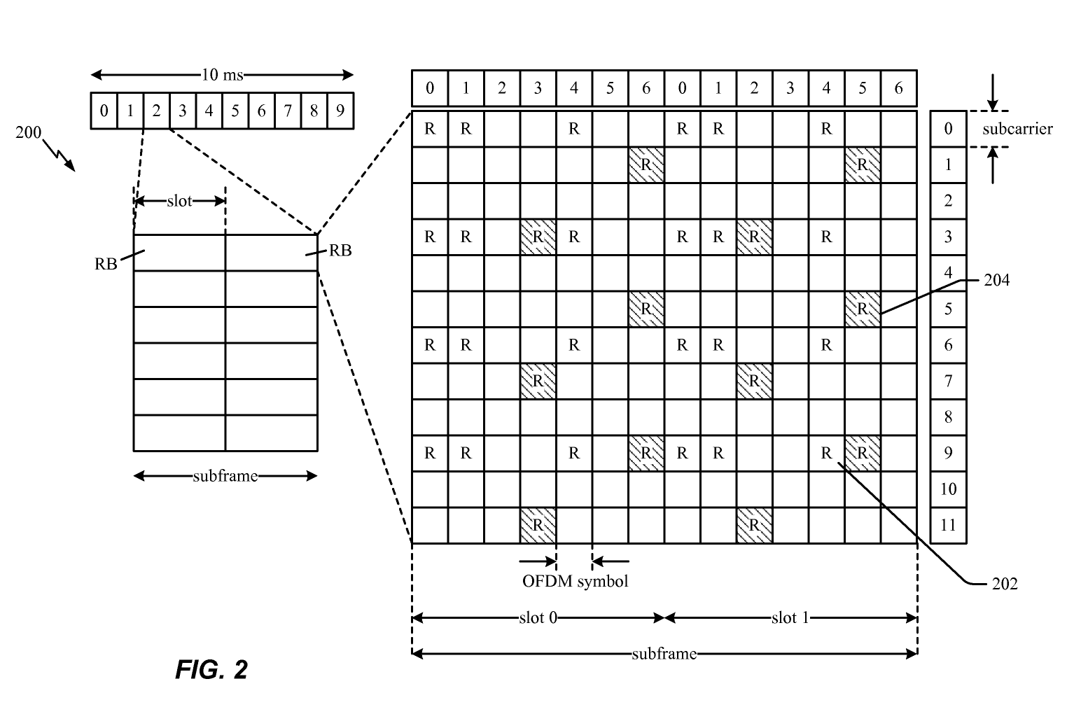

FIG. 2 is a diagram 200 illustrating an example of a downlink frame structure in LTE. A frame (10 ms) may be divided into 10 equally sized subframes. Each subframe may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 202, 204, include downlink reference signals (DL-RS). The DL-RS include Cell-specific RS (CRS) (also sometimes called common RS) 202 and UE-specific RS (UE-RS) 204.

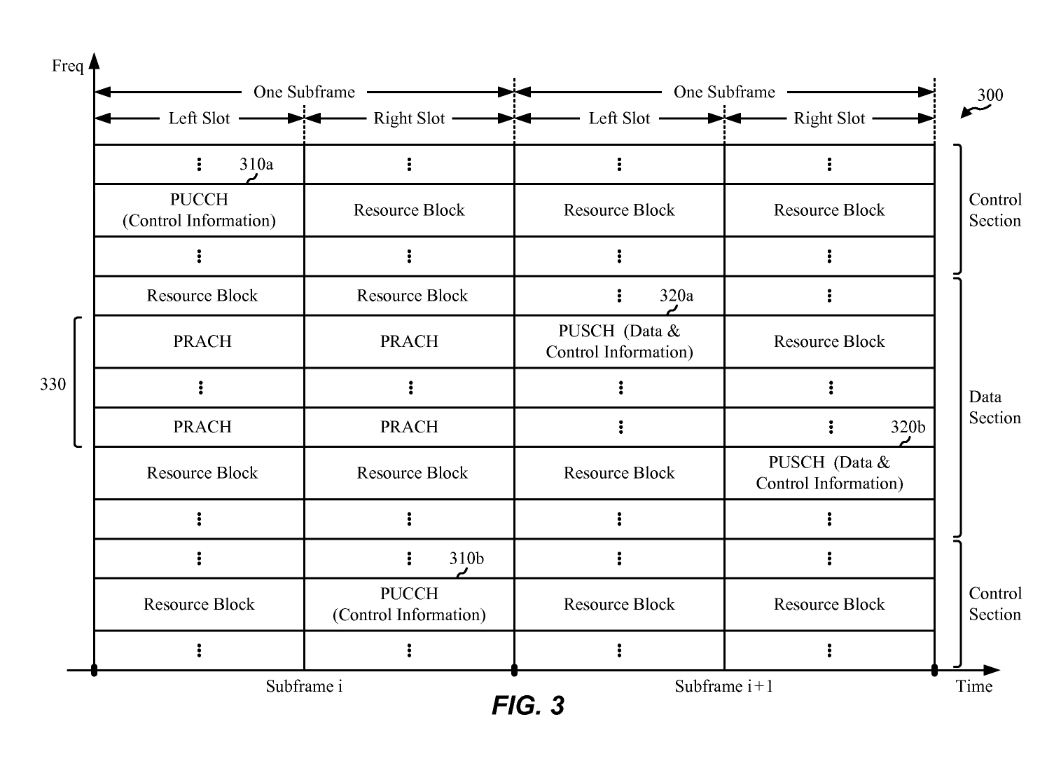

FIG. 3 is a diagram 300 illustrating an example of an uplink frame structure in LTE. The available resource blocks for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The uplink frame structure results in the data section including contiguous subcarriers, which may allow a single UE to be assigned all of the contiguous subcarriers in the data section.

A UE may be assigned resource blocks 310a, 310b in the control section to transmit control information to an eNodeB. The UE may also be assigned resource blocks 320a, 320b in the data section to transmit data to the eNodeB. A set of resource blocks may be used to perform initial system access and achieve uplink synchronization in a physical random access channel (PRACH) 330.

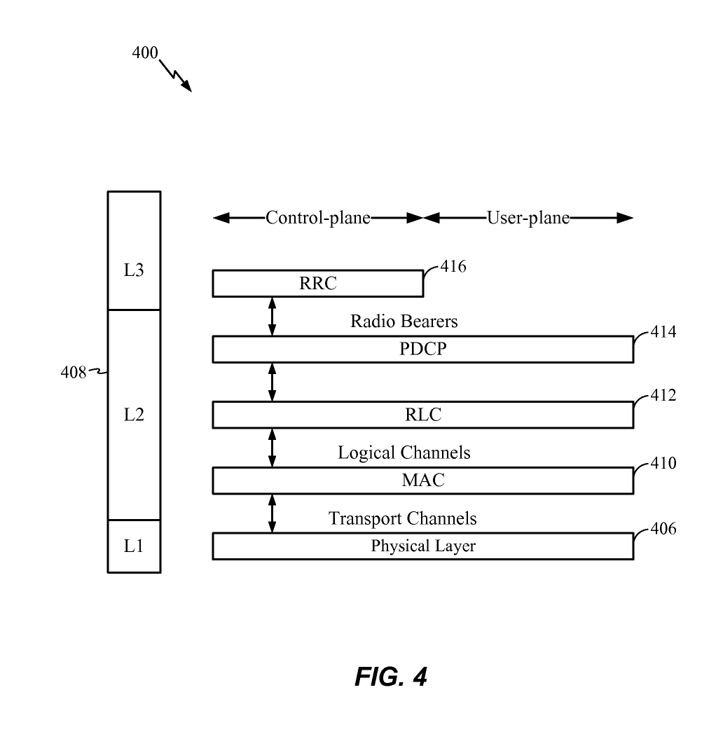

FIG. 4 is a diagram 400 illustrating an example of a radio protocol architecture for the user and control planes in LTE. The radio protocol architecture for the UE and the eNodeB is shown with three layers: Layer 1, Layer 2, and Layer 3. Layer 1 (L1 layer) is the lowest layer and implements various physical layer signal processing functions. The L1 layer will be referred to herein as the physical layer 406. Layer 2 (L2 layer) 408 is above the physical layer 406 and is responsible for the link between the UE and eNodeB over the physical layer 406.

In the user plane, the L2 layer 408 includes a media access control (MAC) sublayer 410, a radio link control (RLC) sublayer 412, and a packet data convergence protocol (PDCP) 414 sublayer, which are terminated at the eNodeB on the network side. Although not shown, the UE may have several upper layers above the L2 layer 408 including a network layer (e.g., IP layer) that is terminated at the PDN gateway 118 on the network side, and an application layer that is terminated at the other end of the connection (e.g., far end UE, server, etc.).

The PDCP sublayer 414 provides multiplexing between different radio bearers and logical channels. The PDCP sublayer 414 also provides header compression for upper layer data packets to reduce radio transmission overhead, security by ciphering the data packets, and handover support for UEs between eNodeBs. The RLC sublayer 412 provides segmentation and reassembly of upper layer data packets, retransmission of lost data packets, and reordering of data packets to compensate for out-of-order reception due to hybrid automatic repeat request (HARQ). The MAC sublayer 410 provides multiplexing between logical and transport channels. The MAC sublayer 410 is also responsible for allocating the various radio resources (e.g., resource blocks) in one cell among the UEs. The MAC sublayer 410 is also responsible for HARQ operations.

In the control plane, the radio protocol architecture for the UE and eNodeB is substantially the same for the physical layer 406 and the L2 layer 408 with the exception that there is no header compression function for the control plane. The control plane also includes a radio resource control (RRC) sublayer 416 in Layer 3 (L3 layer). The RRC sublayer 416 is responsible for obtaining radio resources (e.g., radio bearers) and for configuring the lower layers using RRC signaling between the eNodeB and the UE.

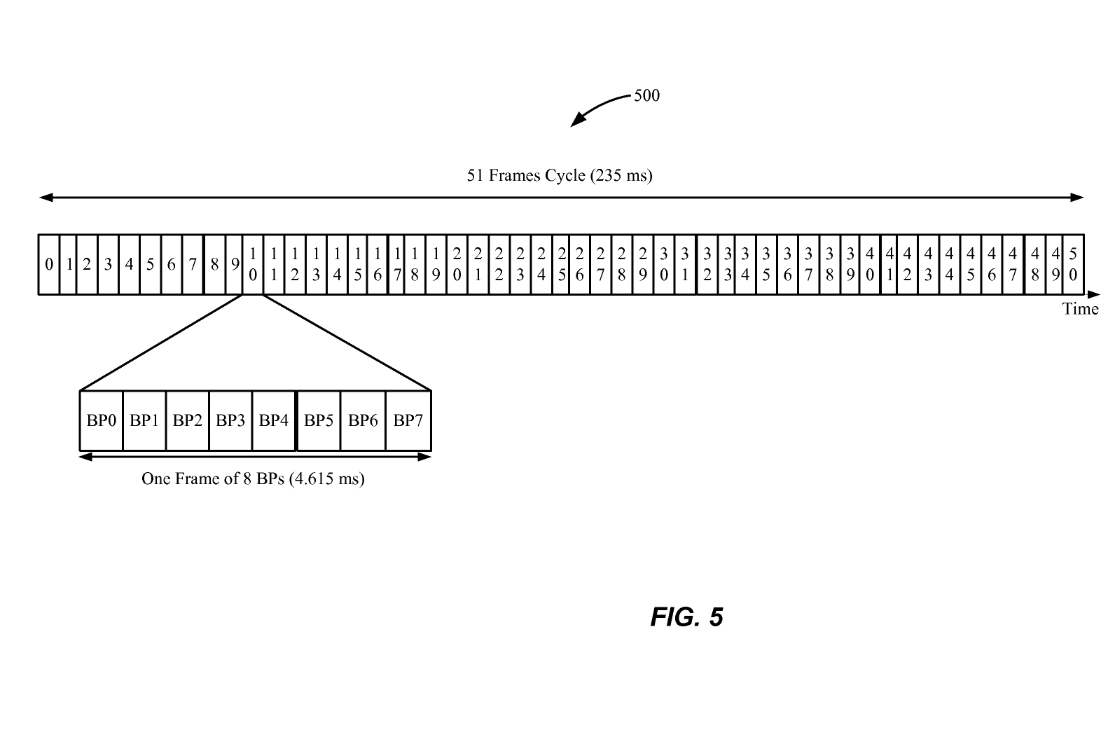

FIG. 5 is a block diagram illustrating an example of a GSM frame structure 500. The GSM frame structure 500 includes fifty-one frame cycles for a total duration of 235 ms. Each frame of the GSM frame structure 500 may have a frame length of 4.615 ms and may include eight burst periods, BP0-BP7.

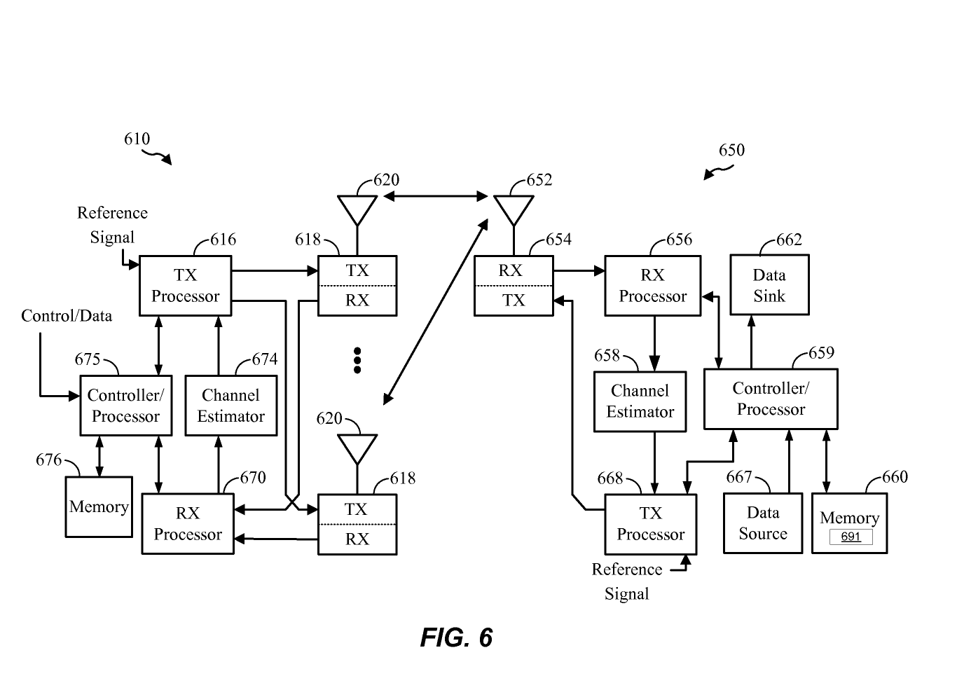

FIG. 6 is a block diagram of a base station (e.g., eNodeB or node B) 610 in communication with a UE 650 with a single receive chain in an access network. In the downlink, upper layer packets from the core network are provided to a controller/processor 675. The controller/processor 675 implements the functionality of the L2 layer. In the downlink, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The TX processor 616 implements various signal processing functions for the L1 layer (e.g., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter (TX) 618. Each transmitter (TX) 618 modulates a radio frequency (RF) carrier with a respective spatial stream for transmitting information, for example according to the frame structure illustrated in FIG. 2.

At the UE 650, a receiver (RX) 654 receives a signal through an antenna 652. The receiver (RX) 654 recovers information modulated onto an RF carrier and provides the information to the receiver (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the base station 610. These soft decisions may be based on channel estimates computed by the channel estimator 658. The soft decisions are then decoded and deinterleaved to recover the data and control signals that were originally transmitted by the base station 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the uplink, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the uplink, a data source 667 is used to provide upper layer packets to the controller/processor 659. The data source 667 represents all protocol layers above the L2 layer. Similar to the functionality described in connection with the downlink transmission by the base station 610, the controller/processor 659 implements the L2 layer for the user plane and the control plane by providing header compression, ciphering, packet segmentation and reordering, and multiplexing between logical and transport channels based on radio resource allocations by the base station 610. The controller/processor 659 is also responsible for HARQ operations, retransmission of lost packets, and signaling to the base station 610.

Channel estimates derived by a channel estimator 658 from a reference signal or feedback transmitted by the base station 610 may be used by the TX processor 668 to select the appropriate coding and modulation schemes, and to facilitate spatial processing. The spatial streams generated by the TX processor 668 are provided to the antenna 652 via a transmitter (TX) 654. The transmitter (TX) 654 modulates an RF carrier with a respective spatial stream for transmitting information, for example according to the frame structure illustrated in FIG. 3.

The uplink transmission is processed at the base station 610 in a manner similar to that described in connection with the receiver function at the UE 650. Each receiver (RX) 618 receives a signal through its respective antenna 620. Each receiver (RX) 618 recovers information modulated onto an RF carrier and provides the information to a RX processor 670. The RX processor 670 may implement the L1 layer.

The controller/processor 675 implements the L2 layer. The controller/processor 675 and 659 can be associated with memories 676 and 660, respectively that store program codes and data. For example, the controller/processors 675 and 659 may provide various functions including timing, peripheral interfaces, voltage regulation, power management, and other control functions. The memories 676 and 660 may be referred to as a computer-readable media. For example, the memory 660 of the UE 650 may store a wireless communication module 691 which, when executed by the controller/processor 659, configures the UE 650 to perform a method for wireless communication with a single receive chain according to aspects of the present disclosure.

In the uplink, the controller/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

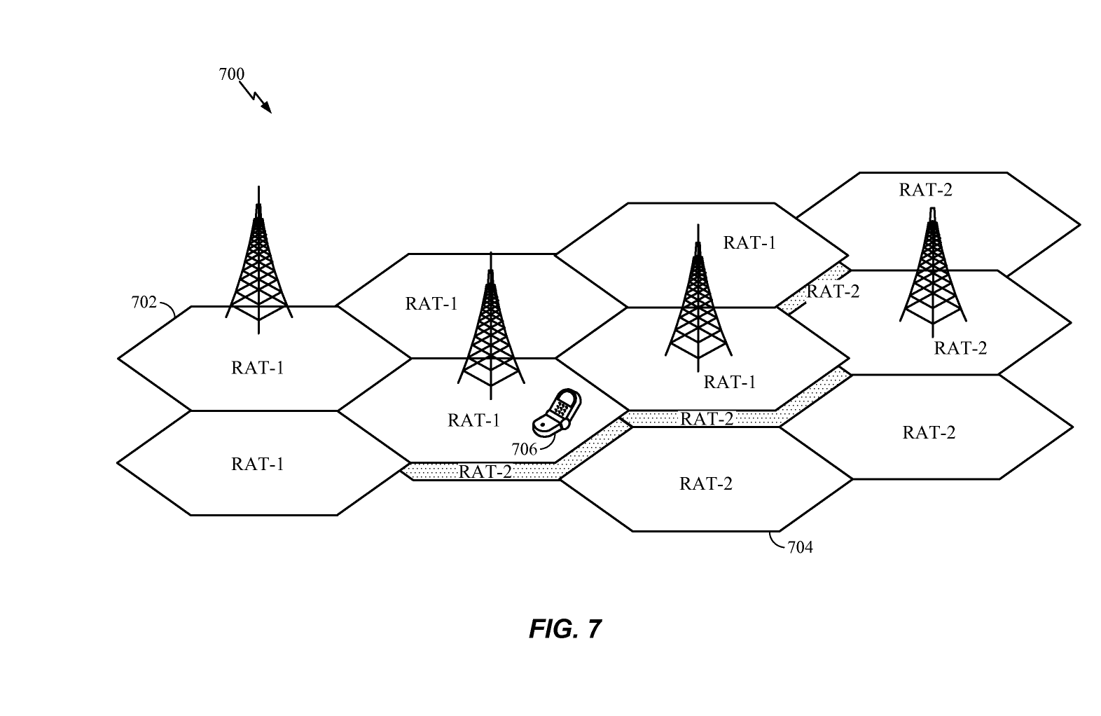

Some networks may be deployed with multiple radio access technologies. FIG. 7 illustrates a network utilizing multiple types of radio access technologies (RATs), such as but not limited to GSM (second generation (2G)), WCDMA (third generation (3G)), LTE (fourth generation (4G)) and fifth generation (5G). Multiple RATs may be deployed in a network to increase capacity. Typically, 2G and 3G are configured with lower priority than 4G. Additionally, multiple frequencies within LTE (4G) may have equal or different priority configurations. Reselection rules are dependent upon defined RAT priorities. Different RATs are not configured with equal priority.

In one example, the geographical area 700 includes RAT-1 cells 702 and RAT-2 cells 704. In one example, the RAT-1 cells are 2G or 3G cells and the RAT-2 cells are LTE cells. However, those skilled in the art will appreciate that other types of radio access technologies may be utilized within the cells. A user equipment (UE) 706 may move from one cell, such as a RAT-1 cell 702, to another cell, such as a RAT-2 cell 704. The movement of the UE 706 may specify a handover or a cell reselection.

A user equipment (UE) may include more than one subscriber identity module (SIM) or universal subscriber identity module (USIM). A UE with more than one SIM may be referred to as a multi-SIM device. In the present disclosure, a SIM may refer to a SIM or a USIM. Each SIM may also include a unique international mobile subscriber identity (IMSI) and service subscription information. Each SIM may be configured to operate in a particular radio access technology. Moreover, each SIM may have full phone features and be associated with a unique phone number. Therefore, the UE may use each SIM to send and receive phone calls. That is, the UE may simultaneously communicate via the phone numbers associated with each individual SIM. For example, a first SIM card can be associated for use in a City A and a second SIM card may be associated for use in a different City B to reduce roaming fees and long distance calling fees. Alternately, a first SIM card may be assigned for personal usage and a different SIM card may be assigned for work/business purposes. In another configuration, a first SIM card provides full phone features and a different SIM card is utilized mostly for data services.

Many multi-SIM devices support multi-SIM multi-standby operation using a single radio frequency (RF) chain to transmit and receive communications. For example, some devices implement a dual-SIM dual-standby (DSDS) system with a single RF chain. A multi-SIM device includes at least a first SIM dedicated to operate in a first RAT and a second SIM dedicated to operate in a second RAT. In one illustrative example, the multi-SIM device includes a first SIM configured to operate in fourth generation (4G) radio access technology (RAT) (e.g., LTE, for example according to aspects illustrated in and/or described with respect to FIGS. 1-4) and a second SIM configured to operate in a second/third generation (2G/3G, for example according to aspects illustrated in and/or described with respect to FIG. 5) RAT, such as TD-SCDMA. The multi-SIM device may operate in other RATs known to those skilled in the art.

When a fourth generation radio access technology subscription is in a radio resource control (RRC) connected mode without voice traffic, the multi-subscriber identity module, multi-standby UE supports tuning away. For example, the UE tunes away from the fourth generation RAT to the second/third generation RAT with the least amount of interruption to the fourth generation connected mode operation. That is, the UE periodically tunes away from the fourth generation RAT to perform one or more communication activities for the second/third generation (2G/3G) RAT. The communication activities may include monitoring for a page on the second/third generation RAT, collecting broadcast control channel (BCCH) system information blocks (SIBs), performing cell reselection, etc. If a page is detected when the UE is tuned to the second/third generation RAT, the multi-subscriber identity module multi-standby UE suspends all operations of the fourth generation RAT and transitions to the second/third generation RAT. When a page is not detected on the second/third generation RAT, the UE tunes back or attempts to tune back to the fourth generation RAT and attempts to recover the original operation of the fourth generation RAT.

During some wireless communications, a buffer of a user equipment (UE) receives data to be transmitted to a network. The data in the buffer may be discarded after an expiration of a discard timer. For example, unsuccessfully transmitted data existing in the buffer are discarded when the discard timer expires prior to their successful transmission. The data may be deemed unsuccessfully transmitted when a negative acknowledgment (NACK) is received or no acknowledgement (ACK) is received prior to expiration of the UE defined discard timer. If a NACK is received before the expiration of the UE defined discard timer, the UE may retransmit and receive an ACK for the retransmission prior to the expiration of the UE defined discard timer. In this case, the UE successfully retransmits the data before the data is discarded. In addition to the UE defined discard timer, the UE may define a retransmission timer to allow the UE to retransmit the data until the expiration of the retransmission timer. Alternatively, the UE may not discard the data until a time expected to receive an ACK ends.

A UE may receive data, from the network, out of sequence. Some of the data from the network, however, may be missing. In this case, the UE starts a network defined discard timer (e.g., downlink discard timer) when the UE receives the out of sequence data. The network indicates the downlink discard timer during call setup (e.g., data call setup) in a first RAT. The UE starts the downlink discard timer when downlink data is received out of sequence.

The network defined discard timer may be a pre-defined time for receiving a missing or out of sequence uplink radio link control protocol data units. When all of the data is received from the network, the UE may pass the data to upper/higher layers of a network layer architecture. In some implementations, however, when the network defined discard timer expires, the UE passes all of the radio link control (RLC) protocol data units (PDUs) to the upper layers, even if some of the radio link control protocol data units are not received. Subsequently, the UE and network only process next expected radio link control protocol data units in sequence.

During reception of the radio link control protocol data unit from the network, the UE may tune away from a first radio access technology (RAT) (e.g., serving RAT) to a second RAT (e.g., target RAT) to perform a tune away procedure. The first RAT and/or the second RAT may be a second generation (2G), GSM, W-CDMA, TD-SCDMA, Wi-Fi, LTE, fifth generation or future RAT. The second RAT may support a second SIM. The tune away procedure may include monitoring for a page on the second RAT. In some instances, however, the UE may tune away from the first RAT to the second RAT to perform the tune away procedure when the buffer of the UE receives data transmitted from the network. Tuning away during this period may cause the network defined timer to expire when the UE is tuned away to perform the tune away procedures on the second RAT.

When the network defined discard timer expires, the radio link control (RLC) protocol data unit (PDUs) transmitted from the network are not received or are unsuccessfully received. Because the UE is tuned away to the second RAT with a single receiver, the initial transmission of the RLC PDU and subsequent retransmissions of the RLC PDU (up to a maximum allowed retransmission) from the network may be missed. Accordingly, the receiver cannot process the retransmitted RLC PDU resulting in an interruption in communication on the first RAT (e.g., a call dropped on the first RAT, which supports a first SIM.)

Similarly, the UE defined timer may expire when the UE is tuned away. As a result, the UE cannot receive an ACK from the network indicating that the network successfully receives the data transmitted by the UE. In this case, the data in the buffer is subsequently discarded if the UE defined discard timer expires before the tune away procedure is completed. It is noted that “the buffer” can be a single buffer or multiple buffers, for example, a receive buffer and a transmit buffer.

### Tune Away Adjustment Procedure

Aspects of the present disclosure may reduce the likelihood of or mitigate call interruptions when a user equipment (UE) tunes away from a first radio access technology (RAT) (e.g., long term evolution (LTE)) to a second RAT (e.g., global system for mobile (GSM)) during a communication procedure at the first RAT. The UE may include a single receive chain where the single receive chain is available for receiving communications from a single RAT at a time. The UE may include a single subscriber identity module (SIM) or more than one SIM.

During the communication procedure with the first RAT, the UE determines whether to adjust a tune away procedure for tuning away from the first RAT to the second RAT. Adjusting the tune away procedure may include delaying or aborting the tune away procedure. The determination is based on a comparison of an expected duration of the tune away procedure and a time remaining before a discard timer expires, a reordering timer for adjusting an order of data at a buffer of the UE expires, a retransmission timer expires and/or an expected time to receive acknowledgement feedback ends. For example, the controller/processor 659 of the UE 650 of FIG. 6 is used to implement the discard timer, the reordering timer, the retransmission timer and the expected time to receive the acknowledgment feedback. In some aspects, the reordering timer and the discard timer may be implemented by the controller/processor 675 of the base station 610. The data (uplink or downlink) may be layer 2 data such as radio link control (RLC) data (e.g., RLC protocol data units (PDUs)) or packet data convergence protocol (PDCP) data.

The downlink (DL) reordering timer is indicated by a network during call setup (e.g., data call setup) in the first RAT and in which the UE starts the downlink reordering timer when downlink data is received out of sequence at a buffer of the UE. The discard timer may be a UE defined uplink (UL) discard timer or a network defined downlink (DL) discard timer. The uplink discard timer may include a UE internal timer that is determined based on quality of service latency specifications. For example, the UE starts the uplink discard timer when uplink data arrives at a buffer of the UE to await transmission. The downlink discard timer may be indicated by the network during call setup in the first RAT. For example, the UE starts the downlink discard timer when downlink data is received out of sequence at the UE. As noted, the downlink data or the uplink data may be layer 2 data such as radio link control (RLC) data (e.g., RLC protocol data units) or packet data convergence protocol (PDCP) data.

In one aspect of the disclosure, the UE aborts or delays the tune away procedure when the duration of the time remaining is less than the expected duration of the tune away procedure. For example, the aborting or delaying of the tune away procedure to monitor for an expected acknowledgement (ACK) to be received while the UE is connected to the first RAT reduces the likelihood of the UE missing the expected ACK that may arrive when the UE is tuned away to the second RAT. Alternatively, the UE performs the tune away procedure when the duration of the time remaining is more than the expected duration of the tune away procedure. In addition, the UE performs the tune away procedure when the duration of the time remaining is more than the expected duration of the tune away procedure by a threshold time value. The threshold time value may be selected to include a next uplink transmission of next downlink reception after the UE returns from the tune away procedure.

For example, if there is a missing downlink radio link control protocol data unit and an expected or calculated duration of the expected tune away procedure is more than the duration of the time remaining, the UE delays or aborts the tuning away procedure to finish receiving missing radio link control protocol data units. Subsequently, the UE resumes the tuning away procedure (e.g., a registration procedure in the second RAT, which supports the second SIM). Thus, the UE effectively avoids the expiration of the network discard timer when the UE is tuned away and effectively avoids call drops due to reaching maximum allowed radio link control retransmission.

In another aspect of the disclosure, the expected duration of the tune away procedure is determined based on a purpose of the tuning away. For example, when the purpose of the tune away procedure is for registration associated with the second RAT, the duration of the tune away procedure is long, e.g., 10 seconds. When the purpose of the tune away procedure is for reselection, the duration of the tune away procedure is short, e.g., 1 second. The expected duration of the tune away procedure is also determined based on the technology or type of the second RAT (e.g., GSM, W-CDMA). An advantage of such a solution is reducing the likelihood of the UE missing retransmissions received from the network, thereby improving throughput. For example, if tune away is for a short time and the tuning away will not cause the reordering timer to expire, the UE performs the tune away. If the tune away is for a long time, the tune away will cause the reordering timer to expire. In this case, it is desirable to not tune away.

The UE starts a discard timer (e.g., uplink (UL) discard timer) defined by the UE when the data is received in the buffer. The data may stay in the buffer until the expiration of the UE defined discard timer, after which the data is discarded. The discard timer is a UE internal timer based on quality of service (QoS) latency specifications and/or whether carrier aggregation is employed or the first RAT activates carrier aggregation. The UE starts the uplink discard timer when uplink data arrives at a buffer of the UE and is awaiting transmission.

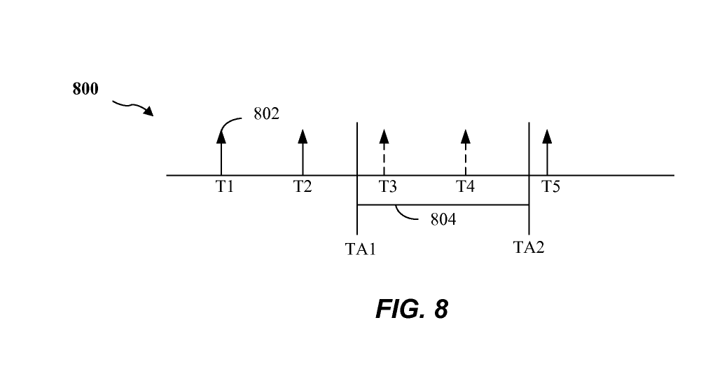

FIG. 8 illustrates an example of a timeline 800 for uplink transmissions 802 and a tune away period 804. As shown in FIG. 8, the uplink transmission 802 may be periodically scheduled to occur at various times T1-T5. For example, data at a buffer at a UE may be periodically scheduled to be transmitted to a base station via a first RAT or serving RAT. Furthermore, a tune away period 804 may be scheduled from a tune away start time TA1 to a tune away end time TA2. For example, during the tune away period 804, the UE tunes away from the first RAT to a second RAT or target RAT to perform measurements on the second RAT. Additionally, as previously discussed, one or more uplink transmissions may be scheduled during the tune away period. For example, as shown in FIG. 8, the uplink transmissions at a third time T3 and a fourth time T4 are scheduled during the tune away period 804. The uplink transmissions scheduled for the third time T3 and the fourth time T4 will not be transmitted because the UE will be tuned away from a serving RAT to a non-serving RAT.

As previously discussed, in one configuration, the UE determines whether to abort or delay the tune away procedure when the duration of a time remaining is less than the expected duration of the tune away procedure. The determination is based on a comparison of an expected duration of the tune away procedure and a time remaining before a discard timer expires, a reordering timer for adjusting an order of data at a buffer of the UE expires, a retransmission timer expires and/or a time expected to receive acknowledgement feedback ends.

To operate with multiple conditions—for example comparison of an expected duration of the tune away procedure with a time remaining before an expiration of a discard timer, a time remaining before an expiration of a downlink reordering timer for adjusting an order of data at a buffer, a time remaining before a retransmission timer expires, and/or a time remaining before an expected time to receive acknowledgement feedback ends—the UE could check each condition in sequence or alternatively, certain ones of the conditions may be processed in parallel, depending on the hardware architecture of the UE. In some embodiments, if any of the conditions are satisfied, the UE adjusts the tune away procedure. In other embodiments, the tune away procedure is only adjusted by the UE when several of the conditions are satisfied (e.g., two or more or the conditions, three or more of the conditions, etc.).

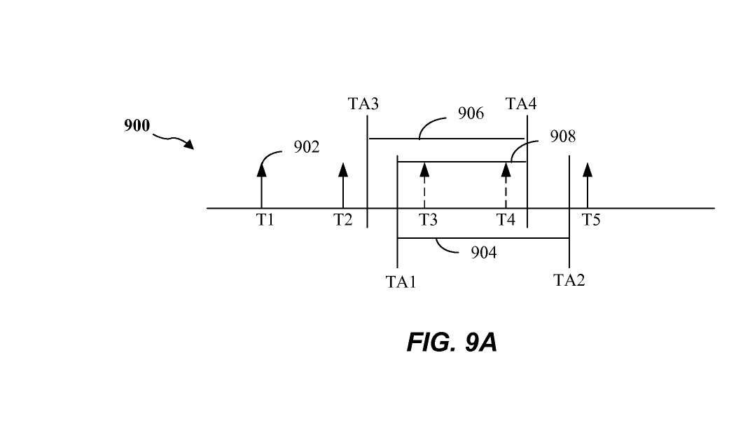

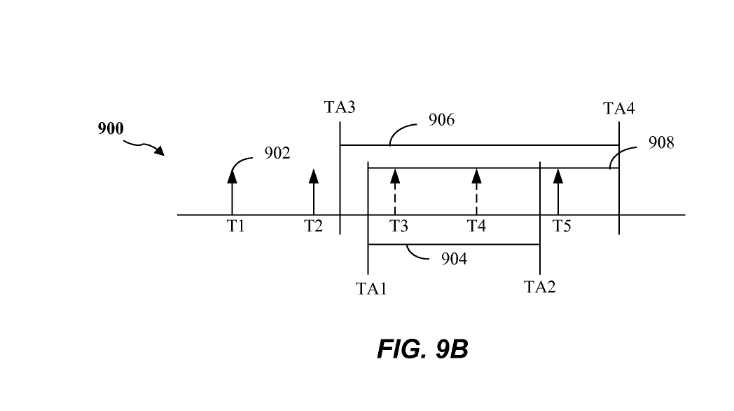

For example, FIGS. 9A and 9B illustrate an example comparison between the expected duration of the tune away procedure and a time remaining before a discard timer expires. FIGS. 9A and 9B are examples of timelines 900 for uplink transmissions 902 illustrating a comparison of an expected tune away period and an uplink discard timer. As noted, the UE starts the uplink discard timer when uplink data arrives at a buffer of the UE to await transmission. The timeline 900 illustrates a duration of the uplink discard timer 906 juxtaposed against an expected duration 904 (or tune away period) of the tune away procedure. Similar to the timeline 800 of FIG. 8, the time lines of FIGS. 9A and 9B include the uplink transmissions 902, which may be periodically scheduled to occur at various times T1-T5. The expected duration 904 of the tune away procedure may be scheduled from a tune away start time TA1 to a tune away end time TA2. The uplink discard timer 906 (e.g., 5 seconds) may be scheduled from a uplink discard timer start time TA3 to an uplink discard timer end time TA4.

Referring to FIG. 9A, to determine whether to delay or abort a tune away procedure for tuning away from the first RAT to the second RAT, the UE compares an expected duration 904 of the tune away procedure (e.g., 3 seconds) and a time remaining 908 before the discard timer expires (e.g., 2 seconds). For example, when the duration 908 of the time remaining before the uplink discard timer 906 expires is less than the expected duration 904 of the tune away procedure (as illustrated in FIG. 9A), the UE aborts or delays the tune away procedure.

Referring to FIG. 9B, when the duration 908 of the time remaining before the uplink discard timer 906 (e.g., 4 seconds) expires is more than the expected duration 904 of the tune away procedure (e.g., 3 seconds), the UE performs the tune away procedure. Although FIGS. 9A and 9B are discussed with respect to the uplink discard timer, the discussion may be extended to the downlink discard timer, reordering timer, the retransmission timer and/or the time expected to receive acknowledgement feedback ends.

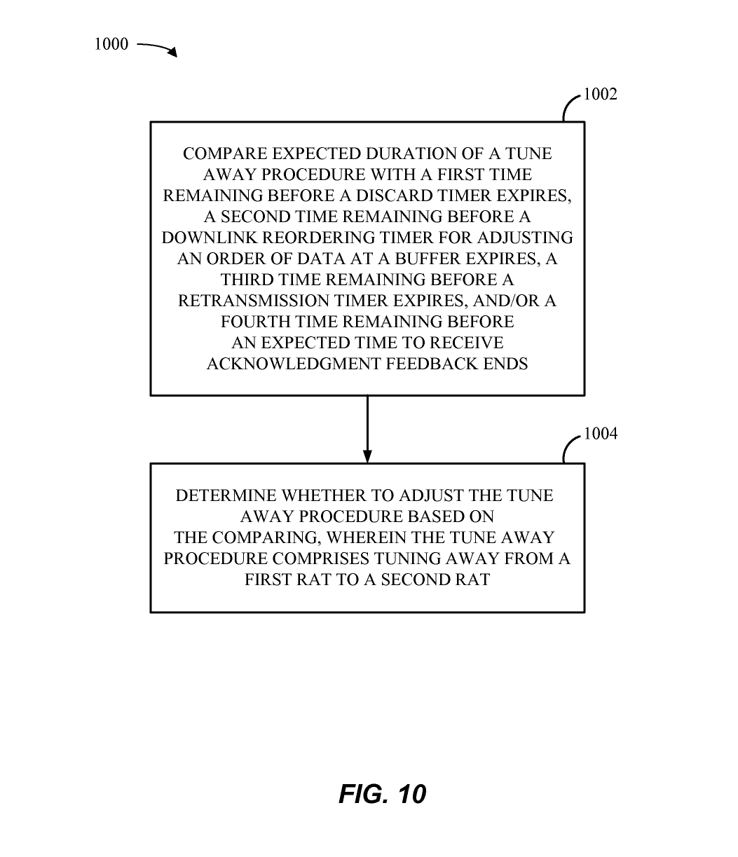

FIG. 10 shows a wireless communication method 1000 according to one aspect of the disclosure. The method is directed to preventing or mitigating call interruptions when a user equipment (UE) tunes away from a first radio access technology (RAT) (e.g., long term evolution (LTE)) to a second RAT (e.g., global system for mobile (GSM)) during a communication procedure at the first RAT. At block 1002, a user equipment (UE) compares an expected duration of a tune away procedure with a first time remaining before a discard timer expires, a second time remaining before a downlink reordering timer for adjusting an order of data at a buffer expires, a third time remaining before a retransmission timer expires, and/or a fourth time remaining before an expected time to receive acknowledgement feedback ends. For example, the controller/processor 659 of the UE 650 of FIG. 6 compares the expected duration of a tune away procedure with the first, second, third, and/or fourth time remaining. At block 1004, the UE determines whether to adjust the tune away procedure based at least in part on the comparing. For example, the controller/processor 659 of the UE 650 of FIG. 6 determines whether to adjust the tune away procedure based at least in part on the comparing. The tune away procedure includes tuning away from a first RAT (radio access technology) to a second RAT.

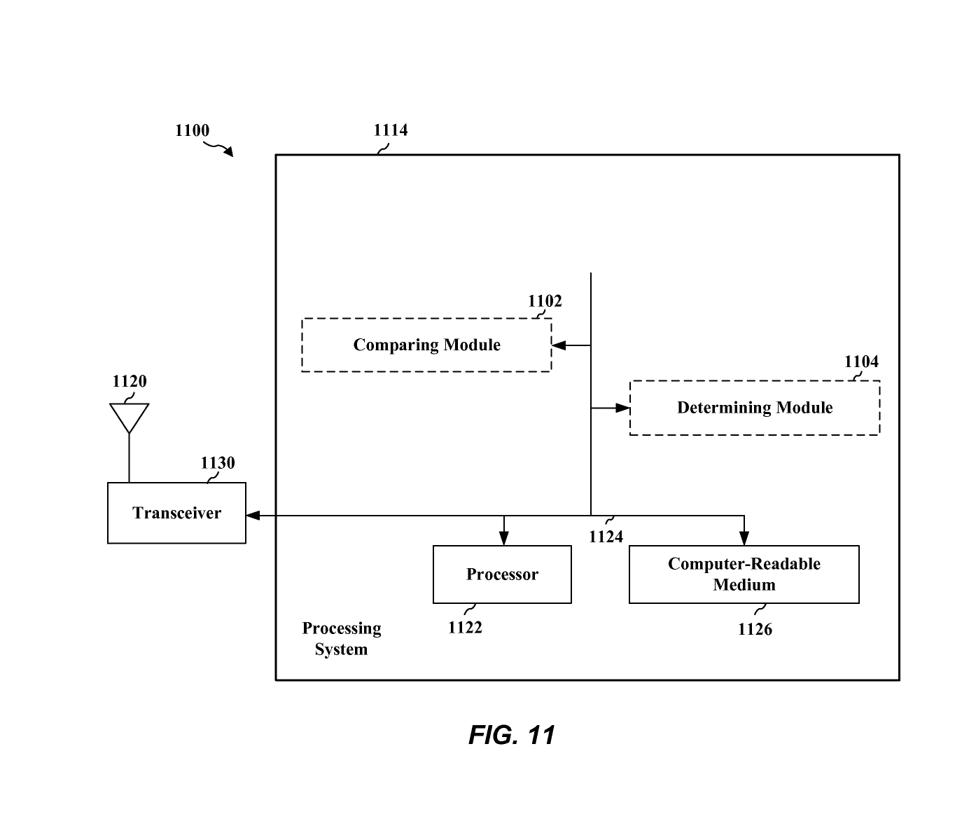

FIG. 11 is a diagram illustrating an example of a hardware implementation for an apparatus 1100 employing a processing system 1114. The processing system 1114 may be implemented with a bus architecture, represented generally by the bus 1124. The bus 1124 may include any number of interconnecting buses and bridges depending on the specific application of the processing system 1114 and the overall design constraints. The bus 1124 links together various circuits including one or more processors and/or hardware modules, represented by the processor 1122 the modules 1102, 1104 and the non-transitory computer-readable medium 1126. The bus 1124 may also link various other circuits such as timing sources, peripherals, voltage regulators, and power management circuits, which are well known in the art, and therefore, will not be described any further.

The apparatus includes a processing system 1114 coupled to a transceiver 1130. The transceiver 1130 is coupled to one or more antennas 1120. The transceiver 1130 enables communicating with various other apparatus over a transmission medium. The processing system 1114 includes a processor 1122 coupled to a non-transitory computer-readable medium 1126. The processor 1122 is responsible for general processing, including the execution of software stored on the computer-readable medium 1126. The software, when executed by the processor 1122, causes the processing system 1114 to perform the various functions described for any particular apparatus. The computer-readable medium 1126 may also be used for storing data that is manipulated by the processor 1122 when executing software.

The processing system 1114 includes a comparing module 1102 for comparing an expected duration of a tune away procedure with a first time remaining before a discard timer expires, a second time remaining before a downlink reordering timer for adjusting an order of data at a buffer expires, a third time remaining before a retransmission timer expires, and/or a fourth time remaining before an expected time to receive acknowledgement feedback ends. The processing system 1114 also includes a determining module 1104 for determining whether to adjust the tune away procedure based at least in part on the comparing. The modules 1102, 1104 may be software modules running in the processor 1122, resident/stored in the computer-readable medium 1126, one or more hardware modules coupled to the processor 1122, or some combination thereof. For example, when the comparing module 1102 is a hardware module, the comparing module 1102 includes the controller/processor 659 of FIG. 6. When the determining module 1104 is a hardware module, the determining module 1104 includes the controller/processor 659. In some aspects, one or more of the timers recited above may be implemented in the controller/processor 659. The processing system 1114 may be a component of the UE 650 of FIG. 6 and may include the memory 660, and/or the controller/processor 659.

In one configuration, an apparatus such as a UE 650 is configured for wireless communication including means for comparing. In one aspect, the comparing means may be the receive processor 656 of FIG. 6, the transmit processor 668 of FIG. 6, the controller/processor 659 of FIG. 6, the memory 660 of FIG. 6, the wireless communication module 691 of FIG. 6, the comparing module 1102 of FIG. 11, the processor 1122 of FIG. 11 and/or the processing system 1114 of FIG. 11 configured to perform the aforementioned means. In one configuration, the means functions correspond to the aforementioned structures. In another aspect, the aforementioned means may be a module or any apparatus configured to perform the functions recited by the aforementioned means.

In one configuration, an apparatus such as a UE 650 is configured for wireless communication including means for determining. In one aspect, the determining means may be the receive processor 656 of FIG. 6, the transmit processor 668 of FIG. 6, the controller/processor 659 of FIG. 6, the memory 660 of FIG. 6, the wireless communication module 691 of FIG. 6, the determining module 1104 of FIG. 11, the processor 1122 of FIG. 11 and/or the processing system 1114 of FIG. 11 configured to perform the aforementioned means. In one configuration, the means functions correspond to the aforementioned structures. In another aspect, the aforementioned means may be a module or any apparatus configured to perform the functions recited by the aforementioned means.

Additionally, an apparatus such as a UE 650 may be configured to include means for adjusting the tune away procedure. In one aspect, the adjusting means may include, for example, the controller/processor 659, the memory 660, and/or the processing system 1114 configured to perform the aforementioned means. The UE 650 may also be configured to include means for performing the tune away procedure. In one aspect, the performing means may include, for example, the controller/processor 659, the memory 660, and/or the processing system 1114 configured to perform the aforementioned means. In one configuration, the means functions correspond to the aforementioned structures. In another aspect, the aforementioned means may be a module or any apparatus configured to perform the functions recited by the aforementioned means.

Several aspects of a telecommunications system has been presented with reference to LTE and GSM systems. As those skilled in the art will readily appreciate, various aspects described throughout this disclosure may be extended to other telecommunication systems, network architectures and communication standards, including those with high throughput and low latency such as 4G systems, 5G systems and beyond. By way of example, various aspects may be extended to other UMTS systems such as W-CDMA, high speed downlink packet access (HSDPA), high speed uplink packet access (HSUPA), high speed packet access plus (HSPA+) and TD-CDMA. Various aspects may also be extended to systems employing long term evolution (LTE) (in FDD, TDD, or both modes), LTE-Advanced (LTE-A) (in FDD, TDD, or both modes), CDMA2000, evolution-data optimized (EV-DO), ultra mobile broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the term “signal quality” is non-limiting. Signal quality is intended to cover any type of signal metric such as received signal code power (RSCP), reference signal received power (RSRP), reference signal received quality (RSRQ), received signal strength indicator (RSSI), signal to noise ratio (SNR), signal to interference plus noise ratio (SINR), etc.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication for a UE (user equipment) with a single receive chain, comprising:
comparing an expected duration of a tune away procedure with a first time remaining before an expiration of a discard timer, a second time remaining before an expiration of a downlink reordering timer for adjusting an order of data at a buffer, a third time remaining before a retransmission timer expires, and/or a fourth time remaining before an expected time to receive acknowledgement feedback ends; and
determining whether to adjust the tune away procedure based at least in part on the comparing,
wherein the tune away procedure comprises tuning away from a first RAT (radio access technology) to a second RAT.

2. The method of claim 1, further comprising adjusting the tune away procedure when the first, second, third, or fourth time remaining is less than the expected duration of the tune away procedure.

3. The method of claim 2, in which adjusting the tune away procedure comprises aborting or delaying the tune away procedure.

4. The method of claim 1, further comprising performing the tune away procedure when the first, second, third, or fourth time remaining is longer than the expected duration of the tune away procedure.

5. The method of claim 1, in which the discard timer comprises an uplink discard timer, the uplink discard timer being an internal timer of the UE determined based at least in part on quality of service (QoS) latency specifications and/or whether carrier aggregation is activated by the first RAT.

6. The method of claim 5, in which the uplink discard timer is defined by the UE during call setup in the first RAT and in which the UE activates the uplink discard timer when uplink data arrives at the buffer of the UE.

7. The method of claim 6, in which the uplink data comprises layer 2 data.

8. The method of claim 1, in which the expected duration of the tune away procedure is determined based at least in part on a purpose of the tuning away and/or a type of the second RAT.

9. The method of claim 1, in which the downlink reordering timer is indicated by a network during call setup in the first RAT and in which the UE activates the downlink reordering timer when downlink data is received out of sequence.

10. The method of claim 9, in which the downlink data comprises layer 2 data.

11. An apparatus for wireless communication for a UE (user equipment) with a single receive chain, comprising:
means for comparing an expected duration of a tune away procedure with a first time remaining before an expiration of a discard timer, a second time remaining before an expiration of a downlink reordering timer for adjusting an order of data at a buffer, a third time remaining before a retransmission timer expires, and/or a fourth time remaining before an expected time to receive acknowledgement feedback ends; and
means for determining whether to adjust the tune away procedure based at least in part on the comparing,
wherein the tune away procedure comprises tuning away from a first RAT (radio access technology) to a second RAT.

12. The apparatus of claim 11, further comprising means for adjusting the tune away procedure when the first, second, third or fourth time remaining is less than the expected duration of the tune away procedure.

13. The apparatus of claim 12, in which the adjusting means is configured to abort or delay the tune away procedure.

14. The apparatus of claim 11, further comprising means for performing the tune away procedure when the first, second, third, or fourth time remaining is longer than the expected duration of the tune away procedure.

15. The apparatus of claim 11, in which the discard timer comprises an uplink discard timer, the uplink discard timer being an internal timer of the UE determined based at least in part on quality of service (QoS) latency specifications and/or whether carrier aggregation is activated by the first RAT.

16. An apparatus for wireless communication for a UE (user equipment) with a single receive chain, comprising:
a memory;
a transceiver configured for wireless communication; and
at least one processor coupled to the memory and the transceiver, the at least one processor configured:
to compare an expected duration of a tune away procedure with a first time remaining before an expiration of a discard timer, a second time remaining before an expiration of a downlink reordering timer for adjusting an order of data at a buffer, a third time remaining before a retransmission timer expires, and/or a fourth time remaining before an expected time to receive acknowledgement feedback ends; and
to determine whether to adjust the tune away procedure based at least in part on the comparing,
wherein the tune away procedure comprises tuning away from a first RAT (radio access technology) to a second RAT.

17. The apparatus of claim 16, in which the at least one processor is further configured to adjust the tune away procedure when the first, second, third or fourth time remaining is less than the expected duration of the tune away procedure.

18. The apparatus of claim 17, in which the at least one processor is further configured to adjust by aborting or delaying the tune away procedure.

19. The apparatus of claim 16, in which the at least one processor is further configured to perform the tune away procedure when the first, second, third, fourth time remaining is longer than the expected duration of the tune away procedure.

20. The apparatus of claim 16, in which the discard timer comprises an uplink discard timer, the uplink discard timer being an internal timer of the UE determined based at least in part on quality of service (QoS) latency specifications and/or whether carrier aggregation is activated by the first RAT.

21. The apparatus of claim 20, in which the uplink discard timer is defined by the UE during call setup in the first RAT and in which the UE activates the uplink discard timer when uplink data arrives at the buffer of the UE.

22. The apparatus of claim 21, in which the uplink data comprises layer 2 data.

23. The apparatus of claim 16, in which the expected duration of the tune away procedure is determined based at least in part on a purpose of the tuning away and/or a type of the second RAT.

24. The apparatus of claim 16, in which the downlink reordering timer is indicated by a network during call setup in the first RAT and in which the UE activates the downlink reordering timer when downlink data is received out of sequence.

25. The apparatus of claim 24, in which the downlink data comprises layer 2 data.

26. A non-transitory computer-readable medium having non-transitory program code recorded thereon, the program code comprising:
program code to compare an expected duration of a tune away procedure with a first time remaining before an expiration of a discard timer, a second time remaining before an expiration of a downlink reordering timer for adjusting an order of data at a buffer, a third time remaining before a retransmission timer expires, and/or a fourth time remaining before an expected time to receive acknowledgement feedback ends; and
program code to determine whether to adjust the tune away procedure based at least in part on the comparing,
wherein the tune away procedure comprises tuning away from a first RAT (radio access technology) to a second RAT.

27. The non-transitory computer-readable medium of claim 26, further comprising program code to adjust the tune away procedure when the first, second, third or fourth time remaining is less than the expected duration of the tune away procedure.

28. The non-transitory computer-readable medium of claim 27, further comprising program code to adjust the tune away procedure by aborting or delaying the tune away procedure.

29. The non-transitory computer-readable medium of claim 26, further comprising program code to perform the tune away procedure when the first, second, third or fourth time remaining is longer than the expected duration of the tune away procedure.

30. The non-transitory computer-readable medium of claim 26, in which the discard timer comprises an uplink discard timer, the uplink discard timer being an internal timer of a UE (user equipment) determined based at least in part on quality of service (QoS) latency specifications and/or whether carrier aggregation is activated by the first RAT.
